(19) United States
(12) Patent Application Publication
(10) Pub. No.: US 2016/0043674 A1
(43) Pub. Date: Feb. 11, 2016

(54) MOTOR DRIVING APPARATUS AND METHOD

(71) Applicant: SAMSUNG ELECTRO-MECHANICS CO., LTD., Suwon-Si (KR)

(72) Inventor: Shin Young CHEONG, Suwon-Si (KR)

(73) Assignee: SAMSUNG ELECTRO-MECHANICS CO., LTD., Suwon-Si (KR)

(21) Appl. No.: 14/679,491

(22) Filed: Apr. 6, 2015

(30) Foreign Application Priority Data
Aug. 5, 2014 (KR) 10-2014-0100596

(51) Int. Cl. H02P 6/20; H02P 6/18

(52) U.S. Cl. CPC H02P 6/20; H02P 6/185

(57) ABSTRACT

A motor driving apparatus may include an inverter unit applying a starting voltage to a plurality of coils of a motor apparatus, a detection unit detecting currents generated by the starting voltage in the plurality of respective coils, and a controlling unit determining inductive rising times of the currents by the starting voltage in the plurality of respective coils using the detected currents and determining a position of a rotor using lengths of the inductive rising times.

### CROSS-REFERENCE TO RELATED APPLICATION

This application claims priority to, and the benefit of, Korean Patent Application No. 10-2014-0100596 filed on Aug. 5, 2014, with the Korean Intellectual Property Office, the disclosure of which is incorporated herein by reference.

### BACKGROUND

The present disclosure relates to a motor driving apparatus and method.

In order to precisely control a motor, a technology for determining a position of a rotor in driving a motor is required.

As a scheme of determining the position of a rotor, a scheme of using a sensor, such as a hall sensor, or the like, has been used. However, in such a scheme, a separate sensor is required, and a motor structure may become relatively complicated in such a case. Therefore, a sensorless scheme has been used.

In a sensorless scheme, the position of the rotor is estimated by detecting currents, voltages, or the like, from a plurality of coils of the motor . However, in such a sensorless scheme, when noises are generated due to an error in measurement, an environmental influence, or the like, the position of the rotor may not be accurately determined.

Korea Patent Laid-Open Publication No. 2011-0077977 and Japanese Patent Laid-Open Publication No. 2009-131098 have disclosed a motor driving apparatus and method in the related art.

### RELATED ART DOCUMENT

(Patent Document 1) Korea Patent Laid-Open Publication No. 2011-0077977

(Patent Document 2) Japanese Patent Laid-Open Publication No. 2009-131098

### SUMMARY

An aspect of the present disclosure may provide a motor driving apparatus and method for accurate detection of a position of a rotor.

According to an aspect of the present disclosure, a motor driving apparatus may include an inverter unit applying a starting voltage to a plurality of coils of a motor apparatus, a detection unit detecting currents generated by the starting voltage in the plurality of respective coils, and a controlling unit determining inductive rising times of the currents by the starting voltage in the plurality of respective coils using the detected currents and determining a position of a rotor using lengths of the inductive rising times.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram for describing a motor driving apparatus according to an exemplary embodiment of the present disclosure;

FIG. 2 is a graph for describing an inductive rising time of a current according to an exemplary embodiment of the present disclosure;

FIG. 3 is a block diagram for describing a controlling unit of the motor driving apparatus according to an exemplary embodiment of the present disclosure;

FIG. 4 is a flow chart for describing a motor driving method according to an exemplary embodiment of the present disclosure;

FIG. 5 is a flow chart illustrating an example of S430 of FIG. 4;

FIG. 6 is a flow chart illustrating an example of S510 of FIG. 5;

FIG. 7 is a flow chart illustrating another example of S510 of FIG. 5; and

FIGS. 8A and 8B are graphs illustrating examples of inductances detected from respective coils in an example of a three-phase motor.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

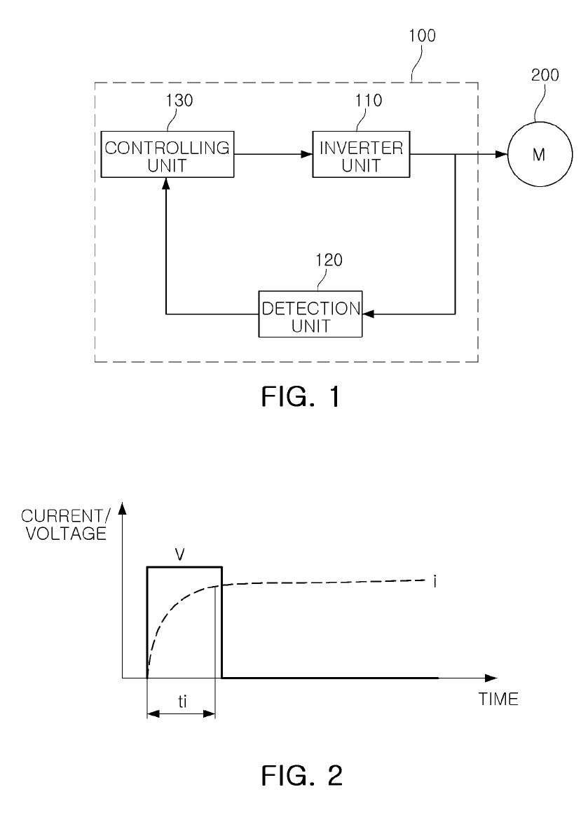

FIG. 1 is a block diagram for describing a motor driving apparatus according to an exemplary embodiment of the present disclosure.

A motor driving apparatus 100 may apply a starting signal to a motor apparatus 200 to control rotation of the motor apparatus 200. The term ‘starting’, as used herein, refers to a control for initially driving the motor apparatus 200 from a stopped state.

Hereinafter, various exemplary embodiments of the present disclosure will be described based on a starting control. However, various exemplary embodiments of the present disclosure are not particularly limited thereto, but may also be applied in a driving state in which the motor apparatus 200 is being operated.

Referring to FIG. 1, the motor driving apparatus 100 may include an inverter unit 110, a detection unit 120, and a controlling unit 130.

The inverter unit 110 may apply a starting voltage to a plurality of coils of the motor apparatus 200. The inverter unit 110 may apply the starting voltage depending on a starting voltage control signal provided from the controlling unit 130.

In an exemplary embodiment, the inverter unit 110 may include a plurality of switches individually connected to the plurality of coils of the motor apparatus 200. The plurality of switches may be switched on/off depending on the starting control signal to provide a predetermined voltage to the plurality of respective coils.

The starting voltage may be applied to each coil in order to drive the motor apparatus 200 in a stop state. Since a position of a rotor may not be recognized in the stop state, a predetermined voltage may be applied in order to recognize the position of the rotor.

In the present disclosure, the starting voltage is not particularly limited. That is, the starting voltage may have a specific pattern or be randomly applied.

The detection unit 120 may detect currents generated by the starting voltage in the plurality of respective coils of the motor apparatus 200.

In an exemplary embodiment, the detection unit 120 may detect the currents generated by the starting voltage using a plurality of current detection units respectively connected to the inverter unit 110 and the plurality of coils of the motor apparatus 200.

The controlling unit 130 may determine inductive rising times of the currents by the starting voltage in the plurality of respective coils using the detected currents. The controlling unit 130 may determine the position of the rotor using lengths of the inductive rising times.

According to an exemplary embodiment, the controlling unit 130 may include a processing unit and a memory. Here, the processing unit may include CPU (Central Processing Unit), GPU (Graphic Processing Unit), Microprocessor, ASIC (Application

Specific Integrated Circuit) and FPGA (Field Programmable Gate Arrays). And the controlling unit 130 may have a plurality of cores. The memory may be a volatile memory, non-volatile memory or a combination thereof.

FIG. 2 is a graph for describing an inductive rising time of a current according to an exemplary embodiment of the present disclosure. Determination of the inductive rising time will be described below with reference to FIG. 2.

When a voltage v is applied to a coil by the inverter unit 11, a current i may be generated. Here, a time ti required for the current i to rise to arrive at a reference value may become the inductive rising time of the current.

The inductive rising time ti of the current may also be determined by a distance up to the rotor in addition to a magnitude of the applied voltage. For example, when the inductive rising time ti of the current is small, it may be appreciated that a corresponding coil to which the voltage is applied is close to the rotor.

Various examples of the controlling unit will be described with reference to FIG. 1.

In an exemplary embodiment, the controlling unit 130 may determine a reference coil having the shortest inductive rising time and determine the position of the rotor using a current or a voltage of the reference coil. As described above with reference to FIG. 2, since it may be appreciated that the rotor is positioned so as to be closest to the reference coil when the inductive rising time ti of the reference coil is shortest, the position of the rotor may be estimated depending on data, for example, a numerical value of a current or a voltage, detected from the reference coil. For example, the controlling unit 130 may include a lookup table including data on positions of the rotor, and may select the position of the rotor corresponding to the current or the voltage detected from the reference coil, from the lookup table.

In an exemplary embodiment, the controlling unit 130 may verify whether or not the reference coil has a shortest inductive rising time using a hysteresis comparison between the inductive rising times. This may be to compensate for an error that may occur at the time of detecting the current in the detection unit 120. That is, an error that may occur due to noise, or the like, may be compensated for by the hysteresis comparison.

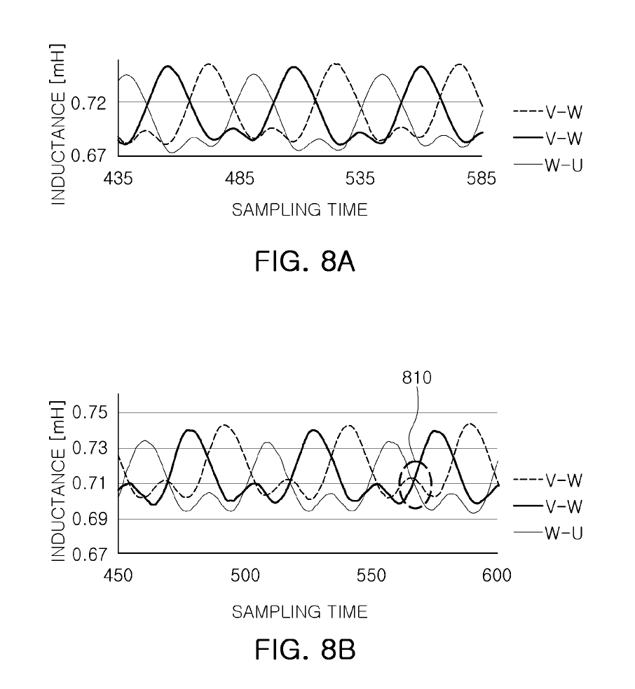

Error compensation of the controlling unit 130 will be described with reference to examples of FIGS. 8A and 8B. FIGS. 8A and 8B are graphs illustrating examples of inductances detected from a respective coil in an example of a three-phase motor.

FIG. 8A illustrates an example in which a normal starting operation is performed by a starting voltage, and FIG. 8B illustrates an example in which noise is detected in a reference numeral 810.

It may be appreciated that in the case of the normal starting operation illustrated in FIG. 8A, the motor may be normally controlled, while in the case of FIG. 8B, the noise is generated in a section corresponding to the reference numeral 810. Therefore, in a general scheme, a driving control may be inaccurately performed due to this noise.

Therefore, the controlling unit 130 may perform the driving control without an error using the hysteresis comparison. Next, various examples of the controlling unit 130 will be described.

In an exemplary embodiment, the controlling unit 130 may perform a hysteresis comparison by comparing inductive rising times of the reference coil having the shortest inductive rising time and one or more coils adjacent to the reference coil with each other. For example, when it is assumed that a current of a first coil after the reference coil is detected, the controlling unit 130 may perform a hysteresis comparison by comparing the inductive rising time of the reference coil and an inductive rising time of the first coil with each other and decide that the starting operation is normally performed when a difference between the inductive rising time of the reference coil and the inductive rising time of the first coil is a reference time or more.

In an exemplary embodiment, the controlling unit 130 may perform a hysteresis comparison by comparing the shortest inductive rising time with the second shortest inductive rising time and the third shortest inductive rising time to verify whether or not the reference coil has a shortest inductive rising time.

In an exemplary embodiment, the controlling unit 130 may provide a starting control signal depending on a new start-up algorithm to the inverter unit 110 when the verification is not successfully made. According to the present exemplary embodiment, the position of the rotor may be initialized and rearranged, thereby removing factors causing an error in detecting the current.

In an exemplary embodiment, the controlling unit 130 may determine inductive rising times of respective positive and negative currents in the plurality of respective coils. Each of the plurality of coils of the motor apparatus 200 may have positive and negative coils, and the plurality of coils may be alternately disposed. Therefore, the controlling unit 130 may individually determine the inductive rising times of the respective positive and negative currents.

In an exemplary embodiment, the controlling unit 130 may calculate the inductive rising times so as to give priority to polarities. That is, the controlling unit 120 may determine the inductive rising times of currents having a first polarity in the plurality of respective coils and then determine the inductive rising times of currents having a second polarity in the plurality of respective coils. For example, in the case of a two-phase motor in which a positive (+) pole of a coil A, a positive (+) pole of a coil B, a negative (−) pole of the coil A, and a negative (−) pole of the coil B are alternately disposed, the controlling unit 130 may sequentially calculate inductive rising times of the positive (+) pole of the coil A, the positive (+) pole of the coil B, the negative (−) pole of the coil A, and the negative (−) pole of the coil B. The reason is that a delay may be generated due to a free wheeling current in the case in which a polarity is reversed in one coil. As a result, the controlling unit 130 determines inductive rising times of the first polarities of the plurality of coils and then determines inductive rising times of the second polarities of the plurality of coils, whereby a control may be rapidly performed.

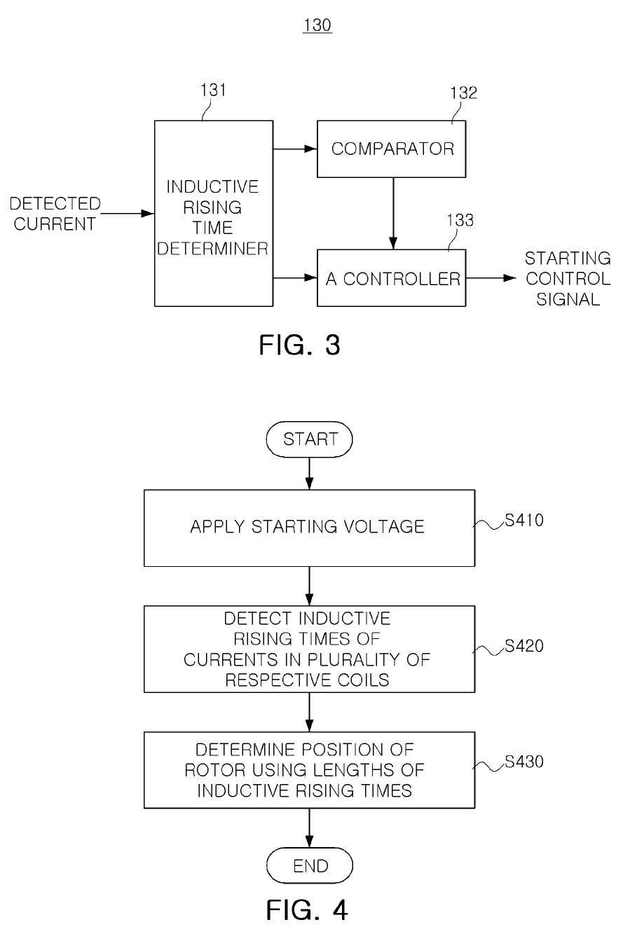

FIG. 3 is a block diagram for describing a controlling unit of the motor driving apparatus according to an exemplary embodiment of the present disclosure.

Referring to FIG. 3, the controlling unit 130 may include an inductive rising time determiner 131, a comparator 132, and a controller 133.

The inductive rising time determiner 131 may determine the inductive rising times of the currents detected from the plurality of respective coils. The inductive rising time determiner 131 may determine the inductive rising times by measuring times required for the currents detected from the plurality of respective coils to arrive at a predetermined value after the starting voltage is applied.

The comparator 132 may compare the lengths of the inductive rising times with each other to determine the reference coil having the shortest inductive rising time.

The controlling unit 132 may verify whether or not the reference coil has a shortest inductive rising time using the hysteresis comparison between the inductive rising times. To this end, the comparator 132 may be implemented as a hysteresis comparator.

In an exemplary embodiment, the comparator 132 may perform a hysteresis comparison by comparing the inductive rising times of the reference coil having the shortest inductive rising time and one or more coils adjacent to the reference coil with each other.

In an exemplary embodiment, the comparator 132 may perform a hysteresis comparison by comparing the shortest inductive rising time with the second shortest inductive rising time and the third shortest inductive rising time to verify whether or not the reference coil has a shortest inductive rising time.

The controller 133 may determine the position of the rotor using the current or the voltage of the reference coil having the shortest inductive rising time.

In an exemplary embodiment, the controller 133 may include the lookup table including the data on the positions of the rotor, and may select the position of the rotor corresponding to the current or the voltage detected from the reference coil, from the lookup table.

In an exemplary embodiment, the controller 133 may provide the starting control signal depending on the new start-up algorithm to the inverter unit 110 when the verification is not successfully made in the comparator 132.

FIG. 4 is a flow chart for describing a motor driving method according to an exemplary embodiment of the present disclosure. Various examples of a motor driving method to be described below may be performed by the motor driving apparatus described above with reference to FIGS. 1 through 3. Therefore, a description for contents that are the same as or correspond to the contents described above with reference to FIGS. 1 through 3 will be omitted in order to avoid an overlapped description.

Referring to FIG. 4, the motor driving control apparatus 100 may apply the starting voltage to the plurality of coils of the motor apparatus 200 (S410).

The motor driving apparatus 100 may detect the inductive rising times of the currents by the starting voltage in the plurality of respective coils (S420).

The motor driving apparatus 100 may determine the position of the rotor using the lengths of the inductive rising times (S430).

In an example of S430, the motor driving apparatus 100 may determine the reference coil having the shortest inductive rising time and determine the position of the rotor using the current or the voltage of the reference coil.

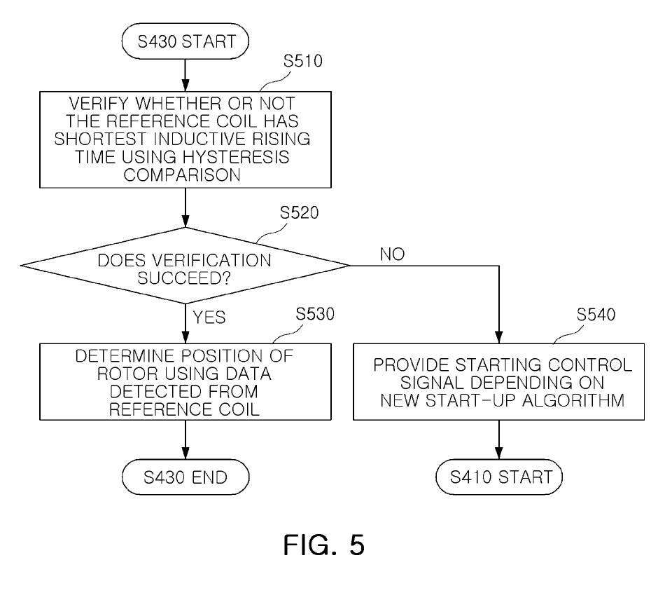

FIG. 5 is a flow chart illustrating an example of 5430 of FIG. 4.

Referring to FIG. 5, the motor driving apparatus 100 may verify whether or not the reference coil has a shortest inductive rising time using the hysteresis comparison between the inductive rising times (S510).

When the verification is successfully made (YES of S520), the motor driving apparatus 100 may determine the position of the rotor using the data, for example, the current or the voltage, detected from the reference coil (S530).

When the verification is not successfully made (NO of S520), the motor driving apparatus 100 may provide the starting control signal depending on the new start-up algorithm. The starting control signal depending on the new start-up algorithm may become a starting voltage and may be provided to the motor apparatus (S410).

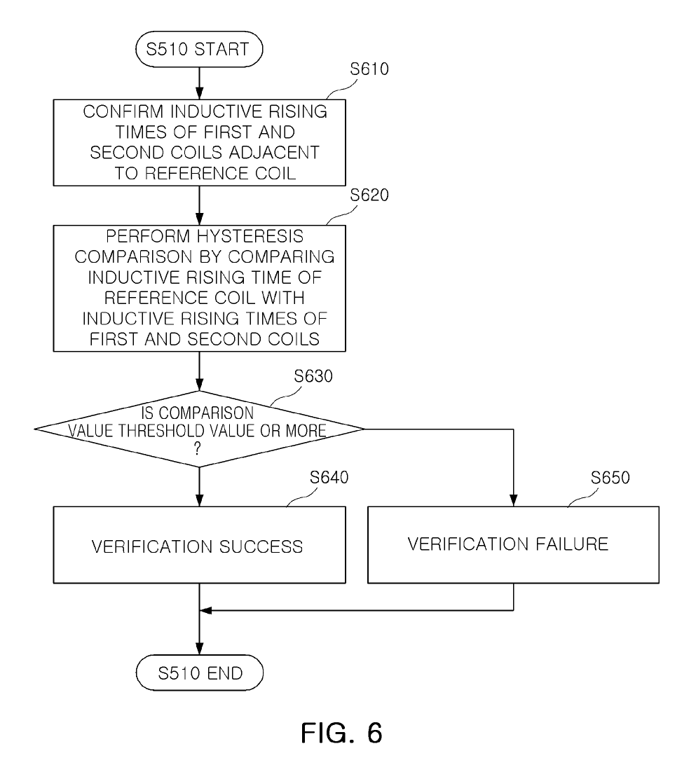

FIG. 6 is a flow chart illustrating an example of S510 of FIG. 5.

Referring to FIG. 6, the motor driving apparatus 100 may confirm the inductive rising times of one or more coils adjacent to the reference coil (S610). An example with respect to a coil led by the reference coil and a second coil lagging behind the reference coil is illustrated in the flow chart of FIG. 6.

The motor driving apparatus 100 may perform a hysteresis comparison by comparing the inductive rising time of the reference coil and the inductive rising time of the first coil with each other and may perform a hysteresis comparison by comparing the inductive rising time of the reference coil and the inductive rising time of the second coil with each other (S620). For example, it may be confirmed whether or not a time corresponding to a difference between the inductive rising time of the reference coil and the inductive rising time of the first coil is a threshold value or more, and it may be confirmed whether or not a time corresponding to a difference between the inductive rising time of the reference coil and the inductive rising time of the second coil is a threshold value or more.

When a comparison result is the threshold value or more (YES of S630), the motor driving apparatus 100 may decide that the verification is successfully made (S640). When the comparison result is less than the threshold value or more (NO of S630), the motor driving apparatus 100 may decide that the verification fails (S650).

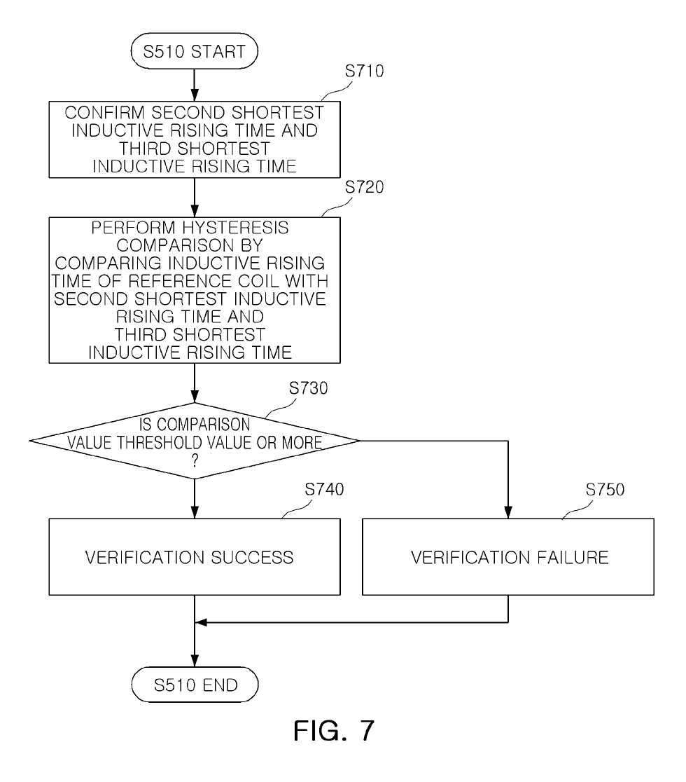

FIG. 7 is a flow chart illustrating another example of S510 of FIG. 5.

Referring to FIG. 7, the motor driving apparatus 100 may confirm the second shortest inductive rising time and the third shortest inductive rising time and may perform a hysteresis comparison by comparing the inductive rising time of the reference coil with the second shortest inductive rising time and the third shortest inductive rising time. For example, it may be confirmed whether or not a time corresponding to a difference between the inductive rising time of the reference coil and the second shortest inductive rising time is a threshold value or more, and it may be confirmed whether or not a time corresponding to a difference between the inductive rising time of the reference coil and the third shortest inductive rising time is a threshold value or more.

When a comparison result is the threshold value or more (YES of S730), the motor driving apparatus 100 may decide that the verification is successfully made (S740). When the comparison result is less than the threshold value or more (NO of S730), the motor driving apparatus 100 may decide that the verification fails (S750).

As set forth above, according to exemplary embodiments of the present disclosure, the position of the rotor may be accurately detected.

While exemplary embodiments have been shown and described above, it will be apparent to those skilled in the art that modifications and variations could be made without departing from the scope of the present invention as defined by the appended claims.

What is claimed is:

1. A motor driving apparatus comprising:
an inverter unit applying a starting voltage to a plurality of coils of a motor apparatus;
a detection unit detecting currents generated by the starting voltage in the plurality of respective coils; and
a controlling unit determining inductive rising times of the currents generated by the starting voltage in the plurality of respective coils, and determining a position of a rotor using lengths of the inductive rising times.

2. The motor driving apparatus of claim 1, wherein the controlling unit determines a reference coil having a shortest inductive rising time and determines the position of the rotor using a current or a voltage of the reference coil.

3. The motor driving apparatus of claim 2, wherein the controlling unit includes a lookup table including data with respect to positions of the rotor, and selects a position of the rotor corresponding to the current or the voltage detected from the reference coil, from the lookup table.

4. The motor driving apparatus of claim 2, wherein the controlling unit verifies the reference coil using hysteresis comparison between the inductive rising times.

5. The motor driving apparatus of claim 4, wherein the controlling unit performs a hysteresis comparison by comparing inductive rising times of one or more coils adjacent to the reference coil with the inductive rising time of the reference coil to thus verify whether or not the reference coil has a shortest inductive rising time among the plurality of coils.

6. The motor driving apparatus of claim 4, wherein the controlling unit performs a hysteresis comparison by comparing the inductive rising time of the reference coil with a second shortest inductive rising time and a third shortest inductive rising time to verify whether or not the reference coil has the shortest inductive rising time among the plurality of coils.

7. The motor driving apparatus of claim 4, wherein the controlling unit provides a starting control signal depending on a new start-up algorithm to the inverter unit when the verification is not successfully made.

8. The motor driving apparatus of claim 1, wherein the controlling unit determines inductive rising times of respective positive and negative currents in the plurality of respective coils.

9. The motor driving apparatus of claim 8, wherein the controlling unit determines the inductive rising times of currents having a first polarity in the plurality of respective coils and subsequently determines the inductive rising times of currents having a second polarity in the plurality of respective coils.

10. The motor driving apparatus of claim 1, wherein the controlling unit includes:
an inductive rising time determiner determining the inductive rising times of the currents detected from the plurality of respective coils;
a comparator comparing the lengths of the inductive rising times with each other to determine a reference coil having a shortest inductive rising time; and
a controller determining the position of the rotor using a current or a voltage of the reference coil.

11. The motor driving apparatus of claim 10, wherein the comparator verifies whether or not the reference coil has the shortest inductive rising time among the plurality of coils, using a hysteresis comparison between the inductive rising times.

12. A motor driving method comprising:
applying a starting voltage to a plurality of coils of a motor apparatus;
detecting inductive rising times of currents by the starting voltage in the plurality of respective coils; and
determining a position of a rotor using lengths of the inductive rising times.

13. The motor driving method of claim 12, wherein the determining of the position of the rotor includes:
determining a reference coil having a shortest inductive rising time; and
determining the position of the rotor using a current or a voltage of the reference coil.

14. The motor driving method of claim 13, wherein the determining of the position of the rotor further includes verifying whether or not the reference coil has a shortest inductive rising time among the plurality of coils, using hysteresis comparison between the inductive rising times.

15. The motor driving method of claim 14, wherein the verifying of the reference coil includes performing a hysteresis comparison by comparing inductive rising times of one or more coils adjacent to the reference coil with the inductive rising time of the reference coil.

16. The motor driving method of claim 14, wherein the verifying of the reference coil includes performing a hysteresis comparison by comparing the inductive rising time of the reference coil with inductive rising times of first and second coils.

17. The motor driving method of claim 14, wherein the determining of the position of the rotor includes providing a starting control signal depending on a new start-up algorithm when the verification is not successfully made.
